(19) United States
(12) Patent Application Publication
(10) Pub. No.: US 2026/0194114 A1
(43) Pub. Date: Jul. 9, 2026

(54) Dog Clutch Actuator and a Dog Clutch System Including the Same

(71) Applicants: HYUNDAI MOTOR COMPANY, Seoul (KR); KIA CORPORATION, Seoul (KR); Seoul National University R&DB Foundation, Seoul (KR)

(72) Inventors: Kyungsik Choi, Hwaseong-si (KR); Hoodam Lee, Hwaseong-si (KR); Taegyu Lee, Hwaseong-si (KR); Won Seok Lee, Hwaseong-si (KR); Hyungkwan Jang, Hwaseong-si (KR); Junhyeok Choi, Hwaseong-si (KR); Byung Ho Min, Hwaseong-si (KR); Yunkyung Ji, Hwaseong-si (KR); Sung-Hoon Ahn, Seoul (KR); Young-Uk Song, Seoul (KR); Semin Ahn, Seoul (KR); Deok Su Kim, Seoul (KR); Midum Oh, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/393,181

(22) Filed: Nov. 18, 2025

(30) Foreign Application Priority Data
Jan. 6, 2025 (KR) 10-2025-0001296

(51) Int. Cl. F16D 23/14; F16D 11/14; F16D 28/00; F16D 125/60

(52) U.S. Cl. CPC F16D 23/14; F16D 11/14; F16D 28/00; F16D 2023/141; F16D 2125/60; F16D 2200/0004

(57) ABSTRACT

A dog clutch actuator includes: an actuator housing; a manipulator movably mounted in a length direction of the actuator housing and including a fork configured to be slidably coupled to a shoulder portion of a dog clutch moving part to selectively move the dog clutch moving part of a dog clutch; an engagement wire of a shape-memory alloy that connects the actuator housing and the manipulator and that is configured to contract based on the supply of electric power to move the manipulator in one direction; and a release wire of a shape-memory alloy that connects the actuator housing and the manipulator and that is configured to contract based on the supply of power to move the manipulator in a different direction.

### CROSS-REFERENCE TO RELATED APPLICATION

This application claims priority to and the benefit of Korean Patent Application No. 10-2025-0001296 filed with the Korean Intellectual Property Office on Jan. 6, 2025, the entire contents of which are incorporated herein by reference.

### BACKGROUND

### (a) Field of the Disclosure

The present disclosure relates to a dog clutch actuator and a dog clutch system including the same, and more particularly, to a dog clutch actuator and system, which may reduce weight, improve space utilization, and increase power delivery efficiency.

### (b) Description of the Related Art

A disconnector system, generally used in vehicles, is a device that separates or connects a motor and drive shaft depending on the driving conditions. The four-wheel drive system of an electric vehicle includes a main drive wheel and an auxiliary drive wheel, and the disconnector system cuts off power to the auxiliary drive wheel. This may reduce unnecessary four-wheel drive and increase power efficiency by approximately 6-8%.

A typical disconnector system utilizes a rotation-type motor and a dog clutch type actuator including a ball screw.

Rotation-type motors and ball screw type actuators have limitations in technological improvement in terms of weight, space utilization, and power delivery efficiency.

Alternatively, a solenoid actuator may be considered, but it has a limitation in that the power consumption must be large in order to obtain sufficient force.

The information contained in this background section is intended to promote understanding of the background of the disclosure and may include subject matter that is not conventional art already known to a person of ordinary skill in the field to which this technology belongs.

### SUMMARY

The present disclosure provides a dog clutch actuator capable of driving a dog clutch by supplying electric power to a shape-memory alloy wire with a simple configuration. The present disclosure also provides a dog clutch system including the same.

A dog clutch actuator according to an embodiment of the present disclosure may include an actuator housing and a manipulator, which is movably mounted in the length direction of the actuator housing. The manipulator may also include a fork that may be slidably coupled to a shoulder portion of a dog clutch moving part to selectively move the dog clutch moving part of a dog clutch. The dog clutch actuator may also include an engagement, shape-memory alloy, wire that connects the actuator housing and the manipulator and contracts according to the supply of electric power to move the manipulator in one direction. The dog clutch actuator may further include a release, shape-memory alloy, wire that connects the actuator housing and the manipulator and contracts according to the supply of power to move the manipulator in a different direction.

The dog clutch actuator may further include at least one or more pulleys mounted on the actuator housing and around which the engagement wire or the release wire is wound.

The manipulator may further include a manipulator wire hole formed or provided to secure the engagement wire and the release wire.

The actuator housing may include an actuator housing wire hole formed or provided to secure the engagement wire and the release wire.

A dog clutch system according to an embodiment of the present disclosure may include a dog clutch housing connected to a first shaft and having a first gear formed or provided therein. The dog clutch system may also include a dog clutch moving part, which is mounted axially on a second shaft coaxially with the first shaft and is movable in the axial direction. The dog clutch moving part may include a second gear selectively engaging the first gear and a shoulder portion formed or provided to protrude outwardly. The dog clutch system may also include a manipulator including a fork slidably coupled to the shoulder portion and a dog clutch actuator including an engagement, shape-memory alloy, wire and a release, shape-memory alloy, wire that contract and move the manipulator upon connection of a power source.

The first gear may be a housing clutch dog formed or provided inside the dog clutch housing and the second gear may be a moving part clutch dog formed or provided on the exterior circumference of the dog clutch moving part.

The dog clutch actuator may further include an actuator housing, and the manipulator may be mounted on the actuator housing so as to be movable in the axial direction of the first shaft and the second shaft.

The dog clutch system according to an embodiment may further include a least one or more pulleys mounted on the actuator housing and around which the engagement wire or the release wire is wound.

The dog clutch system may be equipped with two or more of the dog clutch actuators.

The dog clutch system according to an embodiment may further include a fixing part that limits the movement of the dog clutch moving part when the first gear and the second gear are engaged.

The fixing part may include a locking groove formed or provided on the exterior circumference of the second shaft and an anchor that is selectively inserted into the locking groove.

The fixing part may further include an anchor housing formed or provided in the dog clutch moving part and an anchor spring that is inserted into the anchor housing and elastically supports the anchor.

According to embodiments of the present disclosure, a dog clutch actuator and system having a simple configuration and a relatively small and light weight may be implemented.

According to an embodiment of the present disclosure, an enhancement of fuel efficiency is possible because no additional power is required to maintain the engagement of the clutch by applying a fixed part.

In addition, any effects that can be obtained or expected are directly or implicitly disclosed in the detailed description. That is to say, various effects according to embodiments of the present disclosure are disclosed in or may be derived from the detailed description that follows.

### BRIEF DESCRIPTION OF THE DRAWINGS

The drawings are intended for reference in explaining embodiments of the present disclosure. Therefore, the technical ideas of the present disclosure should not be construed as being limited to the accompanying drawings.

FIG. 1 is a perspective view of a dog clutch actuator and system according to an embodiment of the present disclosure.

FIG. 2 is a cross-sectional view illustrating operation of a dog clutch actuator and system according to a embodiment of the present disclosure.

FIGS. 3 and 4 are drawings illustrating a release operation and an engagement operation of a dog clutch actuator and system according to an embodiment of the present disclosure.

FIGS. 5 and 6 are drawings showing a fixing part of a dog clutch system according to an embodiment of the present disclosure.

FIG. 7 is a top plan view of a dog clutch actuator and system according to a modified embodiment of the present disclosure.

The drawings referenced above are not necessarily drawn to scale but should be understood as presenting rather simplified representations of various features illustrating the basic principles of the present disclosure. For example, certain design features of the present disclosure, including particular dimensions, direction, position, and shape, will be determined in part by the particular intended application and usage environment.

### DETAILED DESCRIPTION OF THE EMBODIMENTS

The technical concepts of the present disclosure are described more fully hereinafter with reference to the accompanying drawings, in which embodiments of the disclosure are shown. As those of ordinary skill in the art should realize, the described embodiments may be modified in various different ways, all without departing from the spirit or scope of the present disclosure.

In order to clearly explain the present disclosure, parts irrelevant to the description have been omitted. Also, the same reference numerals are used for identical or similar components throughout the specification.

The size and thickness of each component shown in the drawings are arbitrarily shown for better understanding and ease of description. The present disclosure is not necessarily limited to what is shown in the drawings, and the size and thickness may be shown as enlarged in order to clearly express various parts and regions.

Also, in the detailed description below, the names of similar components may be distinguished as first, second, etc. to distinguish them from one another. The description below is not necessarily limited by any order suggested by such terms.

Throughout the specification, when a part is said to include a component, this does not mean that other components are excluded, but rather that other components may be included, unless otherwise specifically stated.

Additionally, terms such as “means”, “part”, “unit”, etc., described in the specification mean a comprehensive unit that performs at least one function or operation. Further, when a part, component, device, unit, module, controller, element, or the like of the present disclosure is described as having a purpose or performing an operation, function, or the like, the part, component, device, unit, module, controller, or element should be considered herein as being “configured to” meet that purpose or to perform that operation or function. The present disclosure describes a dog clutch actuator and system that may include a controller for operating or controlling aspects thereof. The controller or other such components may separately embody or be included with a processor and a memory, such as a non-transitory computer readable media, as part of the controller or component.

When a part, such as a layer, membrane, region, or plate, is said to be “on top of” another part, this includes not only cases where the part is directly on top of the other part, but also cases where there are other parts in between.

In contrast, when an element is referred to as being “directly on” another element, there are no intervening elements present.

The terms “vehicle”, “car”, “vehicular” or other similar terms used in this specification include vehicles in general. Such vehicles may include sports utility vehicles (SUVs), buses, trucks, passenger vehicles, various commercial vehicles, ships, various types of boats and vessels, aircraft and the like. Such vehicles may also include hybrid vehicles, electric vehicles, plug-in hybrid electric vehicles, hydrogen fuel vehicles and other alternative fuel (e.g., fuel obtained from resources other than petroleum) vehicles.

Embodiments are hereinafter described in detail with reference to the accompanying drawings.

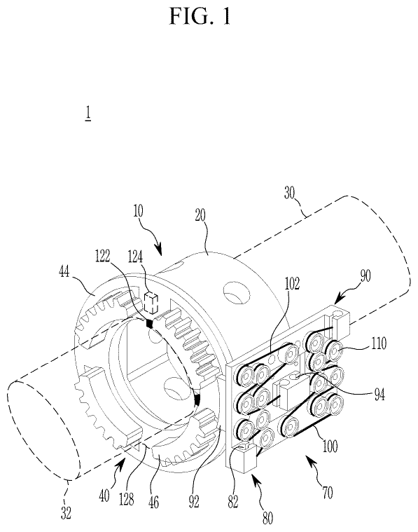

FIG. 1 is a perspective view of a dog clutch actuator according to an embodiment and a view of a dog clutch system including the same.

Referring to FIG. 1, a dog clutch system 1 may include a dog clutch 10 and a dog clutch actuator 70 that drives the dog clutch 10.

In general, a dog clutch (also called a dog box, dog gear, dog ring, clutch dog, or positive clutch) is a type of clutch that joins two rotation shafts or other rotation components through the engagement of interlocking teeth or dogs rather than friction. The two parts of the clutch engage each other by engaging against the other and are designed to rotate at the same speed and never slip. Herein, a “dog” is a tool or device used to lock two components to each other.

By utilizing these characteristics, the dog clutch is used, for example, in transmissions to engage different gears to rotate the input shaft and output shaft.

A four-wheel drive system of an electric vehicle consists of a main drive wheel and an auxiliary drive wheel, and the disconnector system cuts off power between the auxiliary drive unit and the wheels. This may reduce unnecessary four-wheel drive and increase power efficiency by approximately 6-8%.

The rotation-type motor and ball screw type actuator applied to the general disconnector system have limitations in technological improvement in terms of weight, space utilization, and power delivery efficiency.

When applying a solenoid actuator, the power consumption may detrimentally increase in order to obtain sufficient force.

The dog clutch actuator according to the disclosed embodiments and the dog clutch system including the same have a simple configuration. Thus, a relatively small and light dog clutch actuator and a system including the same may be implemented.

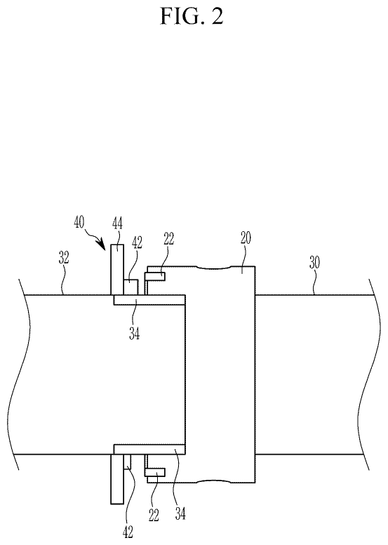

FIG. 2 is a cross-sectional view illustrating operation of a dog clutch actuator according to an embodiment and a view of a dog clutch system including the same.

Referring to FIGS. 1 and 2, the dog clutch 10, which may be applied to the dog clutch system 1, may include a dog clutch housing 20 and a dog clutch moving part 40.

The dog clutch housing 20 is connected to a first shaft 30 and a first gear 22 may be formed or provided in the dog clutch housing 20. For example, the first gear 22 may be formed or provided within the dog clutch housing 20.

The dog clutch moving part 40 may be mounted to be axially movable on a second shaft 32 coaxially arranged with the first shaft 30. The dog clutch moving part 40 may include a second gear 42 that selectively engages the first gear 22 and a shoulder portion 44 that is formed or provided to protrude outwardly, i.e., radially outward.

The first gear 22 may be a housing clutch dog formed or provided on the inner circumference of the dog clutch housing 20. The second gear 42 may be a moving part clutch dog formed or provided on the exterior circumference of the dog clutch moving part 40.

The dog clutch housing 20 and the first shaft 30 may be combined with a bolt, helical gear, etc. The combination of the dog clutch housing 20 and the first shaft 30 should be apparent to those of ordinary skill in the art, so a detailed description thereof has been omitted.

The dog clutch moving part 40 and the second shaft 32 are coupled to enable axial direction movement. For example, a spline or serration 34 is formed or provided on the inner circumference of the dog clutch moving part 40 and the exterior circumference of the second shaft 32. Thus, the dog clutch moving part 40 and the second shaft 32 perform the same rotation and are capable of relative movement in the axial direction.

As illustrated in FIG. 1, an outer gear 46 may be configured to transmit power to other components of the connector system. The connection and function of the outer gear 46 of the disconnector system should also be apparent to those of ordinary skill in the art, so a detailed description thereof has been omitted.

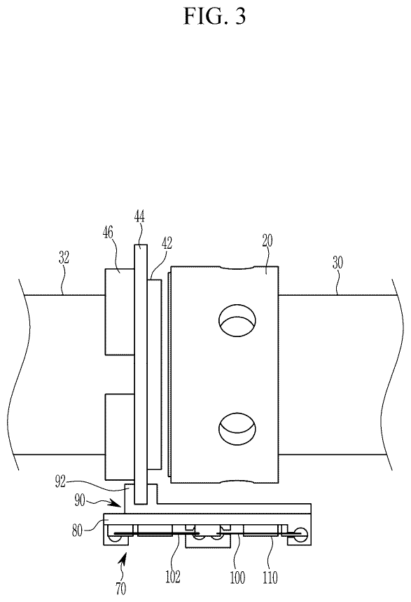

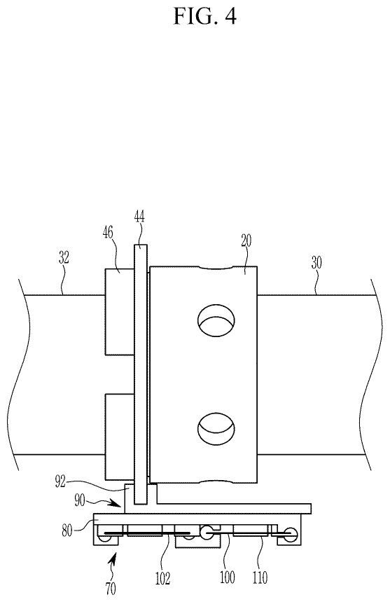

FIGS. 3 and 4 are drawings illustrating a release operation and an engagement operation of a dog clutch actuator and system according to an embodiment of the present disclosure.

Referring to FIGS. 1-4, the dog clutch actuator 70 according to an embodiment may include a manipulator 90 including a fork 92 slidably coupled to the shoulder portion 44. The dog clutch actuator may also include an engagement wire 100 and a release wire 102 that contract and move the manipulator 90 upon connection of a power source. As described herein, the engagement wire 100 and release wire 102 may be formed of a shape-memory alloy, which is generally an alloy that can be deformed when cold but returns to its pre-deformed, i.e., ‘remembered’ or memory shape when heated, such as by application of power, i.e., electrical energy, to the wires.

The fork 92 is slidably coupled with the shoulder portion 44. Slidably coupled here means that the fork 92 is slidably coupled with the shoulder portion 44, which rotates, so that the shoulder portion 44 moves according to the position movement of the fork 92, thereby moving the dog clutch moving part 40.

The shape-memory alloy is an alloy that has the characteristic of recovering its original shape due to a phase transformation (lattice structure change) that occurs at a specific temperature. Depending on the composition of the alloy, the phase transformation temperature may be controlled, and the strain limit and recovery stress due to recovery may be determined depending on the post-processing.

The dog clutch actuator 70 according to an embodiment may include an actuator housing 80 and the manipulator 90 may be mounted movably in the length direction of the actuator housing 80. The length direction of the actuator housing 80 refers to a direction parallel to the first shaft 30 and the second shaft 32 and a direction parallel to the moving direction of the dog clutch moving part 40.

The manipulator 90 and the actuator housing 80 may be movably connected through a rail, slot, etc. (not shown). The movable connection of the manipulator 90 and the actuator housing 80 should be apparent to those of ordinary skill in the art, so a detailed description is omitted.

The engagement wire 100 connects the actuator housing 80 and the manipulator 90 and may move the manipulator 90 in one direction by contracting according to the supply of electric power. Here, the one direction is defined as the direction that brings the dog clutch moving part 40 adjacent to the dog clutch housing 20 so that the dog clutch moving part 40 and the dog clutch housing 20 engage.

The release wire 102 connects the actuator housing 80 and the manipulator 90 and may contract depending on the power supply to move the manipulator 90 in the other, i.e., a different or opposite direction. Here, the other direction, or opposite direction, is defined as a direction that moves the dog clutch moving part 40 away from the dog clutch housing 20 so that the engagement between the dog clutch moving part 40 and the dog clutch housing 20 is released, i.e., so that the dog clutch moving part 40 and dog clutch housing 20 disengage.

Here, the supply of power means supplying electricity to contract either one of the engagement wire 100 or the release wire 102, while power is not supplied to the other or the engagement wire 100 and the release wire 102 simultaneously. In other words, power may be supplied to only one of the wires.

The dog clutch actuator 70 according to an embodiment may further include at least one or more pulleys 110 mounted on the actuator housing 80, and around which the engagement wire 100 or the release wire 102 is wound.

The drawings show that the pulleys 110, around which the engagement wire 100 and the release wire 102 are wound, include eight pieces or pulleys each, in this embodiment. However, the number of pulleys 110 is not limited thereto. The number and arrangement may be selected according to the strain of the engagement wire 100 and the release wire 102, the current required to deform the engagement wire 100 and the release wire 102, the required moving distance of the dog clutch moving part 40, and the like, and is not limited to the configuration shown in the drawings.

In addition, the pulleys 110 around which the engagement wire 100 and the release wire 102 are wound is illustrated as having eight identical pieces or pulleys but is not limited thereto. For example, the number and diameter of the pulleys 110 may be determined based on the force required to engage and release the dog clutch moving part 40 and the dog clutch housing 20, respectively, the required length of the engagement wire 100 and the release wire 102, and the like.

The manipulator 90 may further include a manipulator wire hole 94 formed or provided to secure the engagement wire 100 and the release wire 102.

For example, one end of the engagement wire 100 and/or the release wire 102 may be fixed to the manipulator 90 by inserting a fastener, such as a bolt, into the manipulator wire hole 94. Additionally, by way of example, a cable supplying power to the engagement wire 100 and the release wire 102 may be provided.

The actuator housing 80 may include an actuator housing wire hole 82 formed or provided to secure the engagement wire 100 and the release wire 102.

For example, the other end of the engagement wire 100 and/or the release wire 102 may be secured to the actuator housing 80 by inserting a fastener, such as a bolt, into the actuator housing wire hole 82. Additionally, by way of example, a cable may be provided to supply power to the engagement wire 100 and the release wire 102.

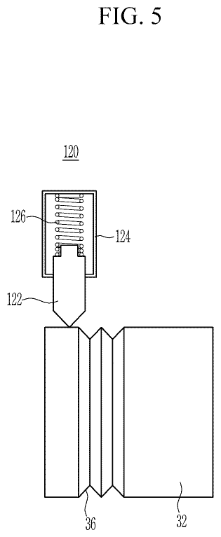

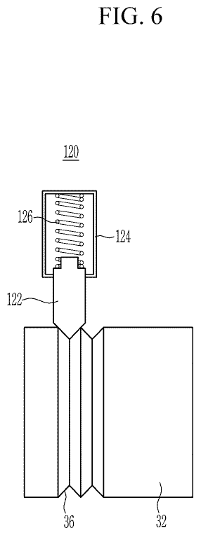

FIGS. 5 and 6 are drawings showing a fixing part of a dog clutch system according to an embodiment.

Referring to FIGS. 1, 5, and 6, the dog clutch system 1 according to an embodiment may further include a fixing part 120 that limits movement of the dog clutch moving part 40 when the first gear 22 and the second gear 42 are engaged.

The fixing part 120 may include a locking groove 36 formed or provided in the exterior circumference of the second shaft 32 and an anchor 122 selectively inserted into the locking groove 36.

The fixing part 120 may further include an anchor housing 124 formed or provided in the dog clutch moving part 40 and may include an anchor spring 126 inserted into the anchor housing 124 and elastically supporting the anchor 122.

As shown in FIG. 1, the anchor 122 protrudes from the inner side of the dog clutch moving part 40 and contacts the second shaft 32.

Although the drawings show the anchor housing 124 formed or provided in the space 128 where a portion of the outer gear 46 is cut off, it is not limited thereto. The anchor housing 124 may be formed or provided on the inner side of the dog clutch moving part 40 accessible to the exterior circumference of the second shaft 32. Additionally, although the drawings show four disconnected spaces 128 of the outer gear 46, this is not limiting. A plurality of disconnected spaces 128, more or less than four, may be formed or provided to mount the anchor housing 124.

In addition, although the drawings show that two locking grooves 36 are formed or provided, this is not limiting. One or three or more locking grooves 36 may be formed or provided as required to secure the dog clutch moving part 40.

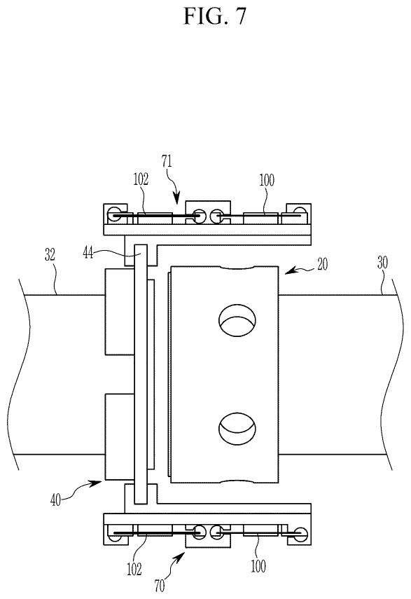

FIG. 7 is a top plan view of a dog clutch actuator and a dog clutch system including the same according to a modified disclosed embodiment of the present disclosure.

Referring to FIG. 7, two or more dog clutch actuators 70 and 71 may be provided.

The drawing shows two dog clutch actuators 70 and 71 applied to the dog clutch system but is not limited thereto. For example, three or more dog clutch actuators may be applied depending on the distance traveled by the dog clutch moving part 40, the strain of the engagement wire 100 and/or the release wire 102, the required current, and the like.

Additionally, the number of mounts of the dog clutch actuator may be determined by considering the moment generated by the coupling and the movement of the fork 92 and the shoulder portion 44.

Hereinafter, the dog clutch actuator according to an embodiment and the operation of the dog clutch system including the same are described with reference to the drawings.

Referring to FIGS. 3 and 5, when the dog clutch housing 20 and the dog clutch moving part 40 are not connected, power or torque of the first shaft 30 is not transmitted to the second shaft 32.

When power delivery of the first shaft 30 and the second shaft 32 is required, current is supplied to the engagement wire 100 under the control of a controller (e.g., transmission controller) not shown.

When current is supplied to the engagement wire 100, the engagement wire 100 reaches the phase transformation temperature through the heat generated by the current, and the engagement wire 100 contracts.

As shown in FIG. 4, when the engagement wire 100 connected to the actuator housing 80 and the manipulator 90 contracts, the manipulator 90 moves in one direction, i.e., to the right in the drawing. The fork 92 pushes the shoulder portion 44, so that the dog clutch moving part 40 moves in the direction of the dog clutch housing 20.

Then, the first gear 22 and the second gear 42 are engaged, and the dog clutch moving part 40 rotates together with the dog clutch housing 20. In other words, the power or torque of the first shaft 30 is transmitted to the second shaft 32.

Also, as shown in FIG. 6, when the dog clutch moving part 40 moves and the anchor 122 is positioned in the locking groove 36, the anchor 122 is inserted into the locking groove 36 by the elastic force of the anchor spring 126.

Even if the current supply to the engagement wire 100 is cut off while the dog clutch moving part 40 and the dog clutch housing 20 are engaged, the engagement between the dog clutch moving part 40 and the dog clutch housing 20 is not released because the anchor 122 is inserted into the locking groove 36.

Therefore, according to the dog clutch actuator and system in the disclosed embodiment, an additional electric power supply is not required to maintain the engagement of the dog clutch moving part 40 and the dog clutch housing 20, so that energy efficiency may be increased.

In addition, when the anchor 122 is inserted into the inclined locking groove 36, the engagement speed of the dog clutch moving part 40 and the dog clutch housing 20 may be increased by the elastic force of the anchor spring 126.

If power delivery of the first shaft 30 and the second shaft 32 is not required, current is supplied to the release wire 102 under the control of the controller.

When current is supplied to the release wire 102, the release wire 102 reaches the phase transformation temperature through the heat generated by the current, and the release wire 102 contracts.

As shown in FIG. 3, when the release wire 102 connected to the actuator housing 80 and the manipulator 90 contracts, the manipulator 90 moves in the other direction, i.e., to the left in the drawing. The fork 92 pushes the shoulder portion 44, so that the dog clutch moving part 40 is separated from the dog clutch housing 20.

Then, the first gear 22 and the second gear 42 are disengaged, and the power or torque of the first shaft 30 is not transmitted to the second shaft 32.

Also, as shown in FIG. 5, the dog clutch moving part 40 moves so that the anchor 122 is separated from the locking groove 36.

As described above, according to the dog clutch actuator and the dog clutch system including the same in the disclosed embodiments, the dog clutch actuator having a simple configuration and a relatively small and light weight, and the system including the same, may be implemented.

According to the dog clutch actuator and the dog clutch system including the same in the disclosed embodiments, an enhancement of fuel efficiency is possible since no additional power is required to maintain the engagement of the clutch by applying the fixing part.

While this disclosure has been described in connection with what are presently considered to be practical embodiments, it is to be understood that the disclosure is not limited to the disclosed embodiments. On the contrary, the present disclosure is intended to cover various modifications and equivalent arrangements included within the spirit and scope of the appended claims.

<Description of symbols>

| | |
|---|---|
| 1: dog clutch system | 10: dog clutch |
| 20: dog clutch housing | 22: first gear |
| 30: first shaft | 32: second shaft |
| 34: spline or serration | 36: locking groove |
| 40: dog clutch moving part | 42: second gear |
| 44: shoulder portion | 46: outer gear |
| 70: dog clutch actuator | 80: actuator housing |
| 82: actuator housing wire hole | |
| 90: manipulator | 92: fork |
| 94: manipulator wire hole | |
| 100: engagement, shape-memory alloy, wire | |
| 102: release, shape-memory alloy, wire | |
| 110: pulley | |
| 120: fixing part | 122: anchor |
| 124: anchor housing | 126: anchor spring |
| 128: space | |

What is claimed is:

1. A dog clutch actuator comprising:
an actuator housing;
a manipulator movably mounted in a length direction of the actuator housing and including a fork configured to be slidably coupled to a shoulder portion of a dog clutch moving part to selectively move the dog clutch moving part of a dog clutch;
an engagement wire of a shape-memory alloy that connects the actuator housing and the manipulator and that is configured to contract based on a supply of electric power to move the manipulator in one direction; and
a release wire of a shape-memory alloy that connects the actuator housing and the manipulator and that is configured to contract based on a supply of power to move the manipulator in a different direction that is different from the one direction.

2. The dog clutch actuator of claim 1, further comprising at least one or more pulleys mounted on the actuator housing and around which the engagement wire or the release wire is wound.

3. The dog clutch actuator of claim 1, wherein the manipulator further comprises a manipulator wire hole to secure the engagement wire and the release wire.

4. The dog clutch actuator of claim 1, wherein the actuator housing comprises an actuator housing wire hole to secure the engagement wire and the release wire.

5. A dog clutch system comprising:
a dog clutch housing connected to a first shaft and having a first gear therein;
a dog clutch moving part, which is mounted axially on a second shaft coaxial with the first shaft and which is movable in an axial direction, and including a second gear selectively engaging the first gear and a shoulder portion protruding outwardly; and
a manipulator including a fork slidably coupled to the shoulder portion, a dog clutch actuator including an engagement wire of a shape-memory alloy and a release wire of a shape-memory alloy that are configured to contract and move the manipulator upon connection of a power source.

6. The dog clutch system of claim 5, wherein:
the first gear is a housing clutch dog inside the dog clutch housing; and
the second gear is a moving part clutch dog on the exterior circumference of the dog clutch moving part.

7. The dog clutch system of claim 5, wherein:
the dog clutch actuator further comprises an actuator housing; and
the manipulator is mounted on the actuator housing so as to be movable in the axial direction of the first shaft and the second shaft.

8. The dog clutch system of claim 7, further comprising at least one or more pulleys mounted on the actuator housing and around which the engagement wire or the release wire is wound.

9. The dog clutch system of claim 5, further comprising two or more of the dog clutch actuators.

10. The dog clutch system of claim 5, further comprising a fixing part that limits the movement of the dog clutch moving part based on the first gear and the second gear being engaged.

11. The dog clutch system of claim 10, wherein the fixing part comprises:
a locking groove on the exterior circumference of the second shaft; and
an anchor that is selectively inserted into the locking groove.

12. The dog clutch system of claim 11, wherein the fixing part further comprises:
an anchor housing in the dog clutch moving part; and
an anchor spring that is inserted into the anchor housing and that elastically supports the anchor.
